(19) United States
(12) Patent Application Publication
(10) Pub. No.: US 2017/0034830 A1
(43) Pub. Date: Feb. 2, 2017

(54) WIRELESS COMMUNICATION DEVICE WITH CHANNEL SCANNING CAPABILITY AND ASSOCIATED METHOD

(71) Applicant: MEDIATEK INC., Hsin-Chu (TW)

(72) Inventors: Ray-Kuo Lin, New Taipei City (TW); Jui-Ching Lin, Hsinchu County (TW)

(21) Appl. No.: 15/155,070

(22) Filed: May 15, 2016

Related U.S. Application Data
(60) Provisional application No. 62/197,592, filed on Jul. 28, 2015.

(51) Int. Cl. H04W 72/08; H04J 3/06; H04W 76/02; H04W 56/00

(52) U.S. Cl. CPC H04W 72/08; H04W 56/001; H04J 3/0658; H04W 76/025

(57) ABSTRACT

A wireless communication device has an antenna module, a synthesizer module, and a control unit. The antenna module has at least a first antenna set and a second antenna set. The synthesizer module is coupled to the antenna module, and has at least a first synthesizer and a second synthesizer. The control unit is coupled to the synthesizer module. While a station wirelessly connects to the wireless communication device via the first antenna set coupled to the first synthesizer in a first channel, the control unit checks at least one channel via the second antenna set coupled to the second synthesizer to find a second channel that is different from the first channel and has a better channel quality than a channel quality of the first channel.

### CROSS REFERENCE TO RELATED APPLICATIONS

This application claims the benefit of U.S. Provisional Application No. 62/197,592, which was filed on Jul. 28, 2015 and is incorporated herein by reference.

### BACKGROUND

The present invention relates to a wireless communication device, and more particularly, to a wireless communication device which can employ channel scanning capability without affecting the current service, and an associated method.

Conventionally, a wireless communication device, such as an access point (AP), determines a working channel at boot-up. If a user wishes to switch to another channel due to poor connecting quality, the user must turn off the wireless communication device and then turn it back on again in order for the access point to locate another channel. Otherwise, the wireless communication device has to ignore the current service and switch to other channels to check the connecting quality. Both these conventional methods result in an inconvenient experience for the user.

### SUMMARY

One of the objectives of the present invention is therefore to provide a wireless communication device which can employ channel scanning capability without affecting the current service, and an associated method.

According to an embodiment of the present invention, a wireless communication device is disclosed, wherein the wireless communication device comprises an antenna module, a synthesizer module and a control unit. The antenna module comprises at least a first antenna set and a second antenna set. The synthesizer module is coupled to the antenna module and comprises at least a first synthesizer and a second synthesizer, and the control unit is coupled to the synthesizer module. When a station wirelessly connects to the wireless communication device with a first channel via the first antenna set, the control unit checks at least one channel via the second antenna set coupled to the second synthesizer to find a second channel different from the first channel, wherein the second channel has a better channel quality than that of the first channel.

According to an embodiment of the present invention, a channel scanning method for a wireless communication device is disclosed. The method comprises: when a station wirelessly connects to the wireless communication device with a first channel via a first antenna set coupled to a first synthesizer, checking at least one channel via a second antenna set coupled to a second synthesizer to find a second channel different from the first channel, wherein the second channel has a better channel quality than that of the first channel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an access point wirelessly connecting to a station according to an embodiment of the present invention.

FIG. 2 is a diagram illustrating an access point performing a channel scan while connecting to the station according to an embodiment of the present invention.

FIG. 3 is a flowchart illustrating a channel scanning method for an access point according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should not be interpreted as a close-ended term such as “consist of”. Also, the term “couple” is intended to mean either an indirect or direct electrical connection. Accordingly, if one device is coupled to another device, that connection may be through a direct electrical connection, or through an indirect electrical connection via other devices and connections.

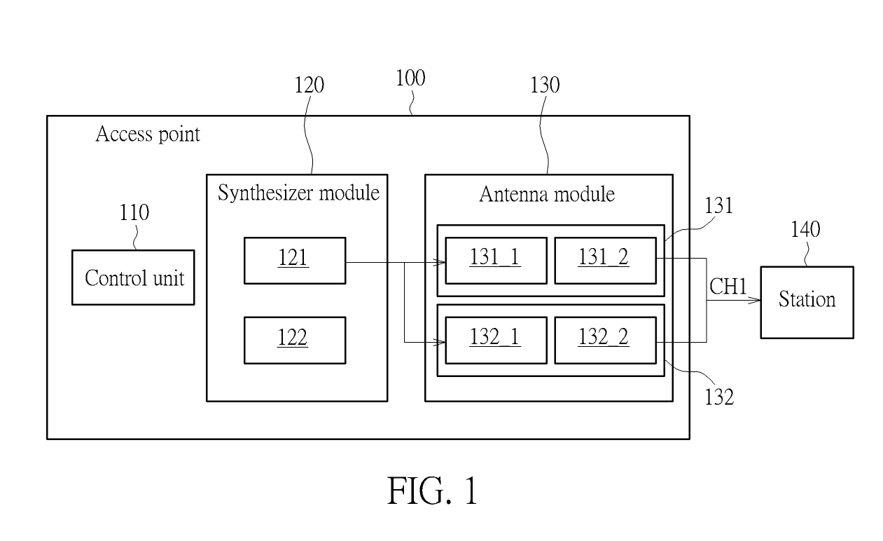

FIG. 1 is a diagram illustrating wireless communication device, such as an access point 100, wirelessly connecting with a station 140 according to an embodiment of the present invention. As shown in FIG. 1, the access point 100 comprises a plurality of hardware circuits, including a control unit 110, a synthesizer module 110 and an antenna module 120. In this embodiment, the synthesizer module 120 comprises synthesizers 121 and 122, and the antenna module 130 comprises antenna sets 131 and 132. The antenna set 131 comprises antennas 131_1 and 131_2, and the antenna set 132 comprises antennas 132_1 and 132_2. In this embodiment, the access point 100 is originally configured to be a 4×4 access point; however, this is not a limitation of the present invention. In other embodiments, the access point 100 may comprise a plurality of antenna sets and a plurality of synthesizers. The number of synthesizers shown in FIG. 1 and the number of antenna sets shown in FIG. 1 are for illustrative purposes only. In other embodiments, a wireless communication device, such as a station, can have similar modules illustrated in FIG. 1.

The station 140 is an electronic device such as a mobile phone, a laptop, or a tablet. When the access point 100 is initiated, the station 140 wirelessly connects with the access point 100 in a channel CH1 via the antenna sets 131 and 132 coupled to the synthesizer 121. The channel CH1 may be in a 2.4 GHz band or a 5 GHz band. During the connection, the control unit 110 periodically examines a connecting quality of the channel CH1. If the connecting quality of the channel CH1 is lower than a threshold value, the control unit 110 automatically triggers an operation of scanning channels without user intervention. It should be noted that the operation of scanning channels can also be triggered by a user input. In another embodiment, the user can manually trigger the operation of scanning channels via an application layer.

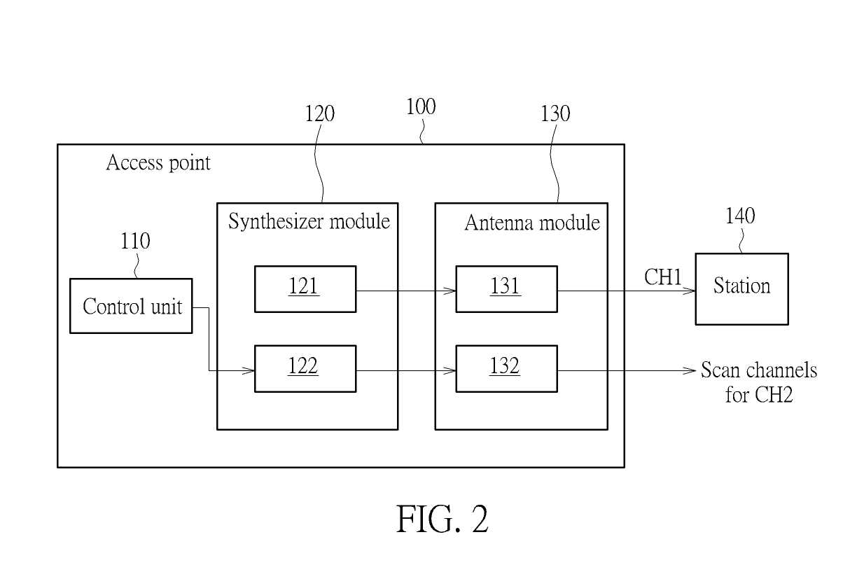

FIG. 2 is a diagram illustrating a wireless communication device, such as an access point 100, performing a channel scan while connecting to a station 140 according to an embodiment of the present invention. As shown in FIG. 2, the control unit 110 triggers the operation of scanning channels via the antenna set 132 by using the synthesizer 122, while the station 140 still wirelessly connects with the access point 100 via the antenna set 131 tuned to the channel CH1. At this point, the access point 100 is configured to be a dual band dual concurrent (DBDC) 2×2+2×2 access point. The access point 100 checks a predetermined channel list comprising a plurality of channels to find a channel CH2 which has a connecting quality better than the connecting quality of the channel CH1. The channel CH2 may be in a 2.4 GHz band or a 5 GHz band. After checking the predetermined list (i.e. after the channel scanning procedure ends), the access point 100 is configured to be the 4×4 access point again (i.e. the embodiment shown in FIG. 1). Namely, the station 140 wirelessly connects with the access point 100 via the antenna sets 131 and 132 coupled to the synthesizer 121. If the channel CH2 is found, the control unit 110 decides whether to switch from the channel CH1 connected with the station 140 to the channel CH2. In another embodiment, after checking the predetermined list (i.e. after the channel scanning procedure ends), the control unit 110 generates a checking report to the application layer for the user to decide whether to switch from the channel CH1 to the channel CH2.

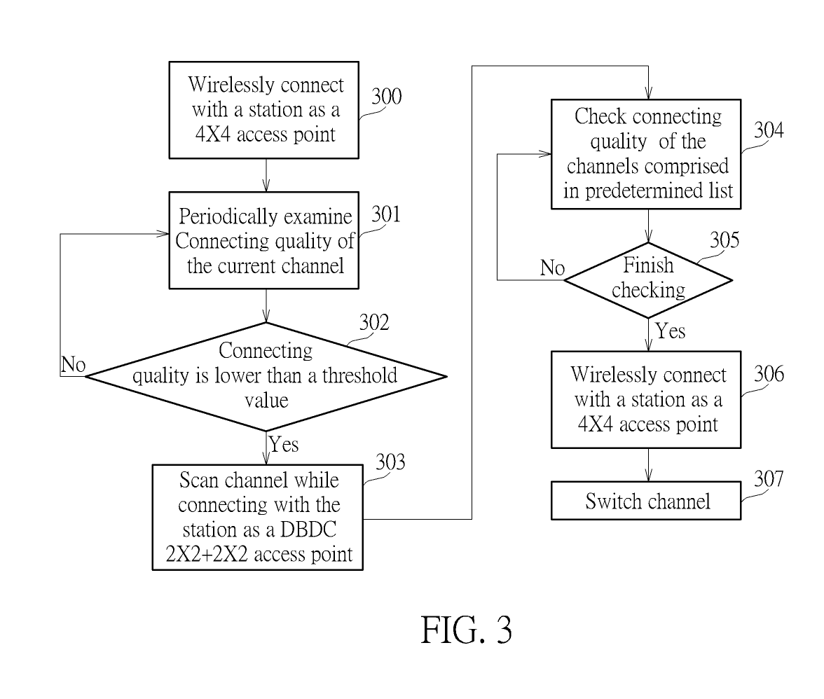

FIG. 3 is a flowchart illustrating a channel scanning method for a wireless communication device, such as an access point, according to an embodiment of the present invention. Provided that the result is substantially the same, the steps are not required to be executed in the exact order shown in FIG. 3. In addition, certain steps may be added to or removed from the flow shown in FIG. 3. The channel scanning method may be summarized by the following steps.

Step 300: Wirelessly connect with the station 140 via the antenna sets 131 and 132 coupled to the synthesizer 121 as a 4×4 access point in the channel CH1.

Step 301: Periodically examine the connecting quality of the channel CH1.

Step 302: Is the connecting quality of the channel CH1 is lower than a threshold value? If yes, go to step 303; otherwise, go back to step 301.

Step 303: Perform channel scan via the antenna set 132 by using the synthesizer 122 while wirelessly connecting with the station 140.

Step 304: Check the connecting quality of the channels comprised in a predetermined list to find a channel CH2 which has a better connecting quality than the connecting quality of the channel CH1.

Step 305: Is the check finished? If yes, go to step 306; otherwise, go back to step 304.

Step 306: Configure the access point to be a 4×4 access point.

Step 307: Switch channels if the channel CH2 is found.

As a person skilled in the art can readily understand details of each step shown in FIG. 3 after reading the above paragraphs, further description is omitted here for brevity. Though the steps shown in FIG. 3 are illustrated with an access point, the steps can also be performed in a station to get similar benefit.

Briefly summarized, the present invention provides a channel scanning method for a wireless communication device by using another synthesizer to perform a channel scan for finding a channel which has a better connecting quality than a currently connected channel. The use of the other synthesizer means that the current service will not be affected when performing the channel scan.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wireless communication device, comprising:
an antenna module, wherein the antenna module comprises at least a first antenna set and a second antenna set;
a synthesizer module, coupled to the antenna module, wherein the synthesizer module comprises at least a first synthesizer and a second synthesizer; and
a control unit, coupled to the synthesizer module;
wherein while a station wirelessly connects to the wireless communication device via the first antenna set coupled to the first synthesizer in a first channel, the control unit checks at least one channel via the second antenna set coupled to the second synthesizer to find a second channel that is different from the first channel and has a better channel quality than a channel quality of the first channel.

2. The wireless communication device of claim 1, wherein the control unit triggers an operation of checking the channel without user intervention.

3. The wireless communication device of claim 2, wherein the control unit periodically examines the channel quality of the first channel; and when the channel quality of the first channel is lower than a threshold value, the control unit triggers the operation of checking the channel by using the second antenna set.

4. The wireless communication device of claim 1, wherein the control unit triggers an operation of checking the channel in response to a user input.

5. The wireless communication device of claim 1, wherein when the second channel is found in the channel checked by the control unit, the control unit further changes a channel connected by the station from the first channel to the second channel without user intervention.

6. The wireless communication device of claim 1, wherein when the second channel is found in the channel checked by the control unit, the control unit further generates a checking report for a user to decide whether to change a channel connected by the station from the first channel to the second channel.

7. The wireless communication device of claim 1, wherein the first channel is in a 2.4 GHz band or a 5 GHz band.

8. The wireless communication device of claim 1, wherein the second channel is in a 2.4 GHz band or a 5 GHz band.

9. The wireless communication device of claim 1, wherein before the control unit starts an operation of checking the channel by using the second antenna set, the station wirelessly connects to the wireless communication device via the first antenna set and the second antenna set in the first channel.

10. The wireless communication device of claim 1, wherein after the control unit finishes an operation of checking the channel by using the second antenna set, the station wirelessly connects to the wireless communication device via the first antenna set and the second antenna set in the first channel.

11. A channel scanning method for a wireless communication device, comprising:
while a station wirelessly connects to the wireless communication device via a first antenna set coupled to a first synthesizer in a first channel, checking at least one channel via a second antenna set coupled to a second synthesizer to find a second channel that is different from the first channel and has a better channel quality than a channel quality of the first channel.

12. The channel scanning method of claim 11, further comprising:
triggering an operation of checking the channel without user intervention.

13. The channel scanning method of claim 12, further comprising:
examining the channel quality of the first channel periodically; and
when the channel quality of the first channel is lower than a threshold value, triggering the operation of checking the channel by using the second antenna set.

14. The channel scanning method of claim 11, further comprising:
triggering an operation of checking the channel in response to a user input.

15. The channel scanning method of claim 11, further comprising:
changing a channel connected by the station from the first channel to the second channel without user intervention when the second channel is found in the channel.

16. The channel scanning method of claim 11, further comprising:
generating a checking report for a user to decide whether to change a channel connected by the station from the first channel to the second channel when the second channel is found in the channel.

17. The channel scanning method of claim 11, wherein the first channel is in a 2.4 GHz band or a 5 GHz band.

18. The channel scanning method of claim 11, wherein the second channel is in a 2.4 GHz band or a 5 GHz band.

19. The channel scanning method of claim 11, further comprising:
before starting an operation of checking the channel by using the second antenna set, wirelessly connecting the station to the wireless communication device via the first antenna set and the second antenna set in the first channel.

20. The channel scanning method of claim 11, further comprising:
after finishing an operation of checking the channel by using the second antenna set, wirelessly connecting the station to the wireless communication device via the first antenna set and the second antenna set in the first channel.
